(19) United States
(12) Patent Application Publication
(10) Pub. No.: US 2020/0130996 A1
(43) Pub. Date: Apr. 30, 2020

(54) SYSTEM AND METHOD FOR ASSIGNING ELEVATOR SERVICE BASED ON PASSENGER USAGE

(71) Applicant: OTIS ELEVATOR COMPANY, Farmington, CT (US)

(72) Inventors: Bhabani Sankar Nanda, Angul (IN); Aditya Swami, Hyderabad (IN)

(21) Appl. No.: 16/662,565

(22) Filed: Oct. 24, 2019

(30) Foreign Application Priority Data
Oct. 27, 2018 (IN) 201811040581

(51) Int. Cl. B66B 1/46; B66B 1/34; B66B 1/24

(52) U.S. Cl. CPC B66B 1/468; B66B 1/3461; B66B 1/2408; B66B 2201/103; B66B 2201/4653; B66B 2201/101; B66B 2201/402; B66B 2201/4638; B66B 2201/4615

(57) ABSTRACT

Disclosed is an elevator system in a building having a plurality of levels with a respective plurality of lobbies, including a first level and a second level having a respective first lobby and second lobby, the system including: an elevator car and a controller that controls the elevator car and communicates over a network with a device for a passenger seeking elevator service at the first lobby, wherein the controller: generates statistical data of elevator usage from dynamically updated accounting of elevator calls from the passenger, renders a first determination from the statistical data that the passenger will request first elevator service at the first lobby, and transmits a first communication to the device that includes instructions to display the first determination for the passenger.

### BACKGROUND

The embodiments herein relate to elevator call servicing and more specifically to a system and method for assigning elevator service based on passenger usage.

### SUMMARY

Disclosed is an elevator system in a building having a plurality of levels with a respective plurality of lobbies, including a first level and a second level having a respective first lobby and second lobby, the system including: an elevator car and a controller that controls the elevator car and communicates over a network with a device for a passenger seeking elevator service at the first lobby, wherein the controller: generates statistical data of elevator usage from dynamically updated accounting of elevator calls from the passenger, renders a first determination from the statistical data that the passenger will request first elevator service at the first lobby, and transmits a first communication to the device that includes instructions to display the first determination for the passenger.

In addition to one or more of the above disclosed features or as an alternate the first determination includes the controller determining from the statistical data that the passenger will seek to travel to the second lobby with the first elevator service.

In addition to one or more of the above disclosed features or as an alternate the controller: renders a second determination to instruct the elevator car to travel to the first lobby to provide elevator service to the passenger, and transmits a second communication to the elevator car to effect the second determination.

In addition to one or more of the above disclosed features or as an alternate the first determination includes the controller rendering from the statistical data a first time of day at the passenger will affect the first request for elevator service.

In addition to one or more of the above disclosed features or as an alternate the controller transmits the first communication to the device proximate in time to the first time of day.

In addition to one or more of the above disclosed features or as an alternate the controller: renders a second determination to instruct the elevator car to travel to the first lobby proximate the first time of day and idle at the first lobby until engaged by the passenger.

In addition to one or more of the above disclosed features or as an alternate the after a first threshold time of idling at the first lobby, the controller releases the elevator car from effecting elevator service for the passenger.

In addition to one or more of the above disclosed features or as an alternate the controller determines that it is statistically probable the passenger will fail to utilize the first elevator service at the first lobby following the passenger effecting the first request for elevator service, and the first communication includes the controller soliciting a confirmation from the passenger that elevator service is being requested, and the controller instructing the elevator car to provide elevator service upon receiving within a second threshold period of time affirmative feedback from the passenger.

In addition to one or more of the above disclosed features or as an alternate the network is a personal area network (PAN).

In addition to one or more of the above disclosed features or as an alternate the network is Bluetooth.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates additional features of the disclosed embodiments; and

FIG. 3 illustrates a process utilizing the disclosed embodiments.

### DETAILED DESCRIPTION

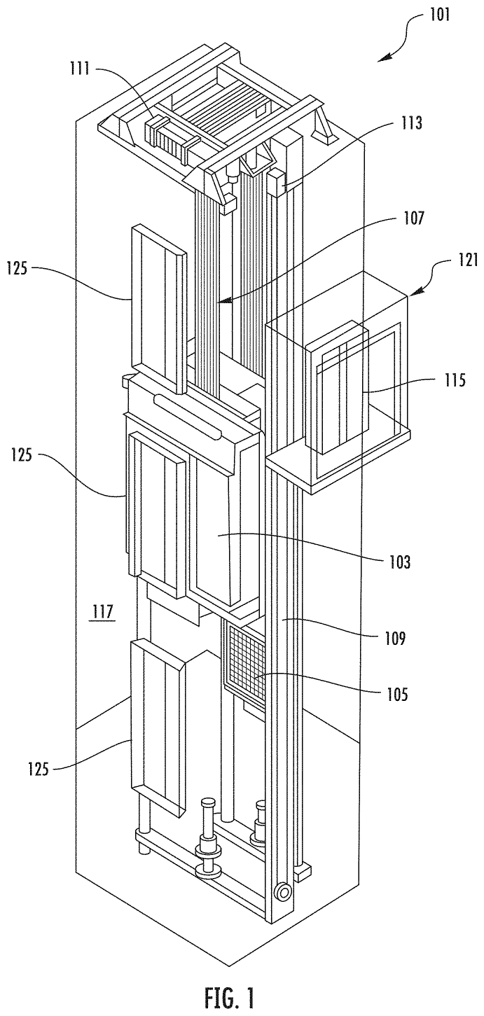

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

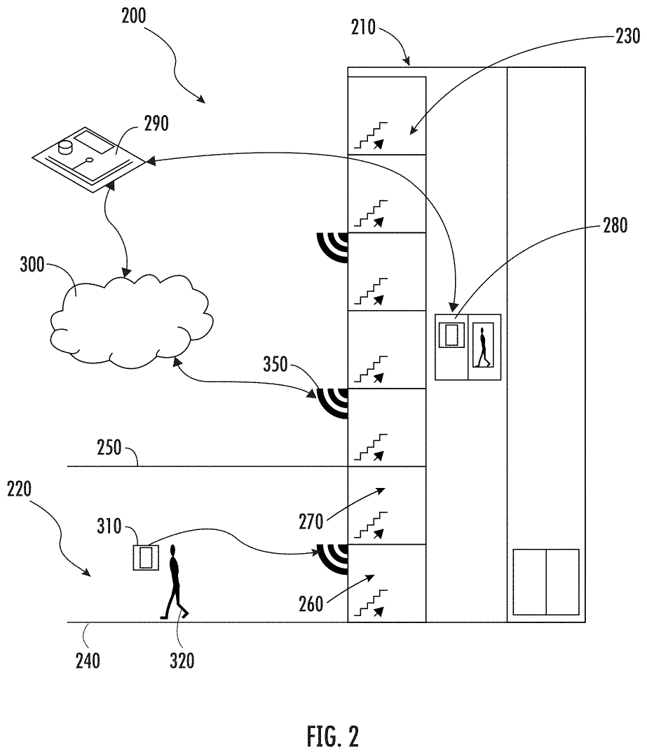

Turning to FIG. 2, disclosed is an elevator system 200 in a building 210 having a plurality of levels 220 with a respective plurality of lobbies 230, including a first level 240 and a second level 250 having a respective first lobby 260 and second lobby 270. The elevator system 200 comprises an elevator car 280 and a controller 290 that controls the elevator car 280 and communicates over a network 300 with a device 310 for a passenger 320 seeking elevator service at the first lobby 260. Device 310 may be a phone, PDA, tablet, watch, wearable or other processor-based device.

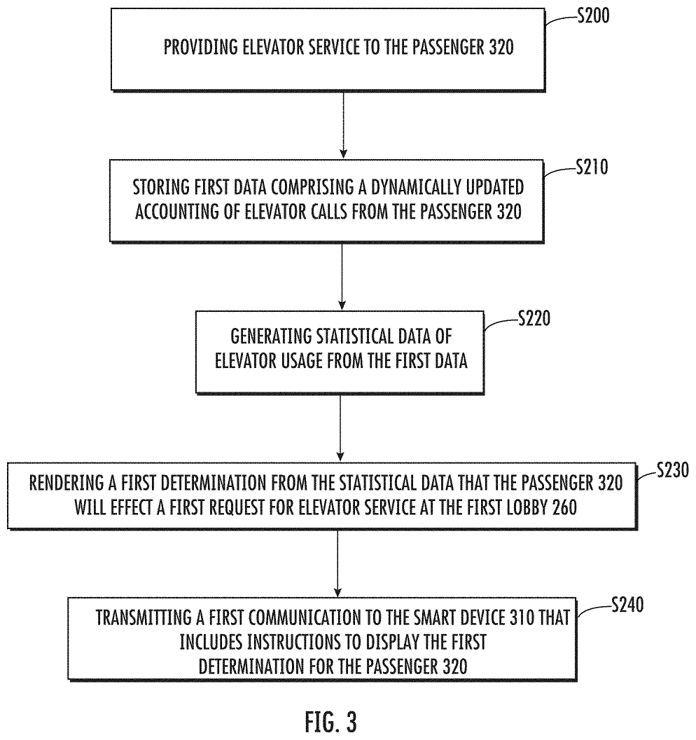

Turning to FIG. 3, the controller 290 performs a process S200 of providing elevator service to the passenger 320. Step S200 includes step S210 of the controller 290 storing first data comprising a dynamically updated accounting of elevator calls from the passenger 320. Step S220 includes the controller 290 generating statistical data of elevator usage from the first data. Step S230 includes the controller 290 rendering a first determination from the statistical data that the passenger 320 will effect a first request for elevator service at the first lobby 260. Step S240 includes the controller 290 transmitting a first communication to the device 310 that includes instructions to display the first determination for the passenger 320.

According to an embodiment the first determination includes the controller 290 determining from the statistical data that the passenger 320 may seek to travel to the second lobby 270 with the first elevator service.

According to an embodiment the controller 290 renders a second determination to instruct the elevator car 280 to travel to the first lobby 260 to provide elevator service to the passenger 320. The controller 290 may transmit a second communication to the elevator car 280 to effect the second determination.

According to an embodiment the first determination includes the controller 290 rendering from the statistical data a first time of day at the passenger 320 will affect the first request for elevator service. The controller 290 may transmit the first communication to the device 310 proximate in time to the first time of day. The controller 290 may render a second determination to instruct the elevator car 280 to travel to the first lobby 260 proximate the first time of day and idle at the first lobby 260 until engaged by the passenger 320. According to an embodiment, after a first threshold time of idling at the first lobby 260, the controller 290 releases the elevator car 280 from effecting elevator service for the passenger 320. This occurs for example when the passenger fails to use requested service.

According to an embodiment, the controller 290 determines that it is statistically probable the passenger 320 will fail to utilize the first elevator service at the first lobby 260 following the passenger 320 effecting the first request for elevator service. The first communication from the controller 290 may include the controller 290 soliciting a confirmation from the passenger 320 that elevator service is being requested. The controller 290 may instruct the elevator car 280 to provide the passenger 320 with elevator service upon receiving within a second threshold period of time affirmative feedback from the passenger 320.

According to an embodiment the network 300 is a personal area network (PAN) and the system includes a beacon 350 with which the smart device connects to the PAN. According to an embodiment the network 300 is Bluetooth.

According to the above embodiments leveraging a passenger's profile information and patterns of elevator usage may enable a controller to generated predictions of user behavioral patterns. When the passenger engages a smart device for calling an elevator, the controller may recommend a destination level based on a prior usage pattern. The controller may park an elevator at a predicted originating level or nearby level in advance of a predicted call. In addition the elevator may identify misusage of elevator requests, thus providing an overall great efficiency of usage for the elevator system.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system in a building having a plurality of levels with a respective plurality of lobbies, including a first level and a second level having a respective first lobby and second lobby, the system comprising:
an elevator car and a controller that controls the elevator car and communicates over a network with a device for a passenger seeking elevator service at the first lobby, wherein the controller:
generates statistical data of elevator usage from a dynamically updated accounting of elevator calls from the passenger,
renders a first determination from the statistical data that the passenger will request first elevator service at the first lobby, and
transmits a first communication to the device that includes instructions to display the first determination for the passenger.

2. The system of claim 1 wherein the first determination includes the controller determining from the statistical data that the passenger will seek to travel to the second lobby with the first elevator service.

3. The system of claim 1 wherein the controller:
renders a second determination to instruct the elevator car to travel to the first lobby to provide elevator service to the passenger, and
transmits a second communication to the elevator car to effect the second determination.

4. The system of claim 1 wherein
the first determination includes the controller rendering from the statistical data a first time of day at the passenger will affect the first request for elevator service.

5. The system of claim 4 wherein the controller transmits the first communication to the device proximate in time to the first time of day.

6. The system of claim 5 wherein the controller:
renders a second determination to instruct the elevator car to travel to the first lobby proximate the first time of day and idle at the first lobby until engaged by the passenger.

7. The system of claim 6 wherein
after a first threshold time of idling at the first lobby, the controller releases the elevator car from effecting elevator service for the passenger.

8. The system of claim 1 wherein the controller determines that it is statistically probable the passenger will fail to utilize the first elevator service at the first lobby following the passenger effecting the first request for elevator service, and
the first communication includes the controller soliciting a confirmation from the passenger that elevator service is being requested, and the controller instructing the elevator car to provide elevator service upon receiving within a second threshold period of time affirmative feedback from the passenger.

9. The system of claim 1 wherein the network is a personal area network (PAN).

10. The system of claim 9 wherein the network is Bluetooth.

11. A method of transporting a passenger in a building having a plurality of levels with a respective plurality of lobbies, including a first level and a second level having a respective first lobby and second lobby,
the building including an elevator system including an elevator car and a controller that controls the elevator car and communicates over a network with a device for the passenger when the passenger seeks elevator service at the first lobby, wherein
the method comprises the controller:
generating statistical data of elevator usage from a dynamically updated accounting of elevator calls from the passenger,
rendering a first determination from the statistical data that the passenger will request first elevator service at the first lobby, and
transmitting a first communication to the device that includes instructions to display the first determination for the passenger.

12. The method of claim 11 wherein the first determination includes the controller determining from the statistical data that the passenger will seek to travel to the second lobby with the first elevator service.

13. The method of claim 11 wherein the controller:
renders a second determination to instruct the elevator car to travel to the first lobby to provide elevator service to the passenger, and
transmits a second communication to the elevator car to effect the second determination.

14. The method of claim 11 wherein
the first determination includes the controller rendering from the statistical data a first time of day at the passenger will affect the first request for elevator service.

15. The method of claim 14 wherein the controller transmits the first communication to the device proximate in time to the first time of day.

16. The method of claim 15 wherein the controller:
renders a second determination to instruct the elevator car to travel to the first lobby proximate the first time of day and idle at the first lobby until engaged by the passenger.

17. The method of claim 16 wherein
after a first threshold time of idling at the first lobby, the controller releases the elevator car from effecting elevator service for the passenger.

18. The method of claim 11 wherein the controller determines that it is statistically probable the passenger will fail to utilize the first elevator service at the first lobby following the passenger effecting the first request for elevator service, and
the first communication includes the controller soliciting a confirmation from the passenger that elevator service is being requested, and the controller instructing the elevator car to provide elevator service upon receiving within a second threshold period of time affirmative feedback from the passenger.

19. The method of claim 11 wherein the network is a personal area network (PAN).

20. The method of claim 19 wherein the network is Bluetooth.
